(19) United States
(12) Patent Application Publication
(10) Pub. No.: US 2008/0073261 A1
(43) Pub. Date: Mar. 27, 2008

(54) INLINE FILTER FITTING

(75) Inventors: Christopher L. Schwab, Toledo, OH (US); Ryan J. Williams, Sylvania, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignee: Eaton Corporation, Cleveland, OH (US)

(21) Appl. No.: 11/860,252

(22) Filed: Sep. 24, 2007

Related U.S. Application Data
(60) Provisional application No. 60/826,613, filed on Sep. 22, 2006.

(51) Int. Cl. B01D 35/30

(52) U.S. Cl. 210/232

(57) ABSTRACT

An inline filter fitting is provided that includes a filter, a first member having a bore configured to house the filter, and a second member removably connected to the first member. In one embodiment, the inline filter fitting includes a first connector configured to connect to a first hose and a second connector configured to connect to a second hose.

### CROSS-REFERENCE TO RELATED APPLICATION

This application claims priority to U.S. Provisional Patent Application No. 60/826,613 filed on Sep. 22, 2006, the disclosure of which is hereby incorporated by reference in its entirety herein.

### BACKGROUND

1. Field of Invention

The present application relates to a filter for a fluid line. In particular, the application relates to an inline filter fitting configured to be placed in a fluid line.

2. Description of the Related Art

Filters are commonly used at one end of a fluid line to collect particles or debris, thereby removing them from the fluid. One example of such a filter is a screen provided at an end of a discharge line of a washing machine. Another known example is an oil filter connected to an engine or an oil pan. In these examples, the filter is connected to a component or to an end of a line.

### SUMMARY

In one embodiment, an inline filter fitting is provided that includes a filter, a first member having a bore configured to house the filter, and a second member removably connected to the first member. The inline filter fitting may include a first connector configured to connect to a first hose and a second connector configured to connect to a second hose.

In another embodiment, an inline filter fitting is provided that includes a housing having at least two connectors, including a first connector and a second connector, and a filter disposed in the housing. The first connector is configured to be attached to a first hose and the second connector is configured to be attached to a second hose.

In yet another embodiment, filter assembly is provided that includes a filter, a housing having a bore configured to house the filter, a first connector configured to connect to a first hose, and a second connector configured to connect to a second hose.

### BRIEF DESCRIPTION OF THE DRAWINGS

It will be appreciated that the illustrated boundaries of elements (e.g., boxes or groups of boxes) in the figures represent one example of the boundaries. One of ordinary skill in the art will appreciate that one element may be designed as multiple elements or that multiple elements may be designed as one element. An element shown as an internal component of another element may be implemented as an external component and vice versa.

Further, in the accompanying drawings and description that follow, like parts are indicated throughout the drawings and description with the same reference numerals, respectively. The figures may not be drawn to scale and the proportions of certain parts have been exaggerated for convenience of illustration.

FIG. 1 is a cross-section of one embodiment of an inline filter fitting connected to a fluid line;

FIG. 2 is a partial cross-section of an alternative embodiment of an inline filter fitting having a filter screen;

FIG. 3 is a top view of a filter screen;

FIG. 4 is a cross-section of another alternative embodiment of an inline filter fitting having a floating filter cartridge;

FIG. 5 is a partial cross-section of another alternative embodiment of an inline filter fitting having a floating filter cartridge with O-rings;

FIG. 6 is a partial cross-section of another alternative embodiment of an inline filter fitting having a threaded filter cartridge;

FIG. 7 is a partial cross-section of an alternative embodiment of a unitary inline filter fitting;

FIG. 8 is a partial cross-section of an another alternative embodiment of an inline filter fitting having two female components and one male component; and

FIG. 9 is a cross-section of another alternative embodiment of an inline filter fitting having threaded connectors connected to a fluid line having threaded connectors.

### DETAILED DESCRIPTION

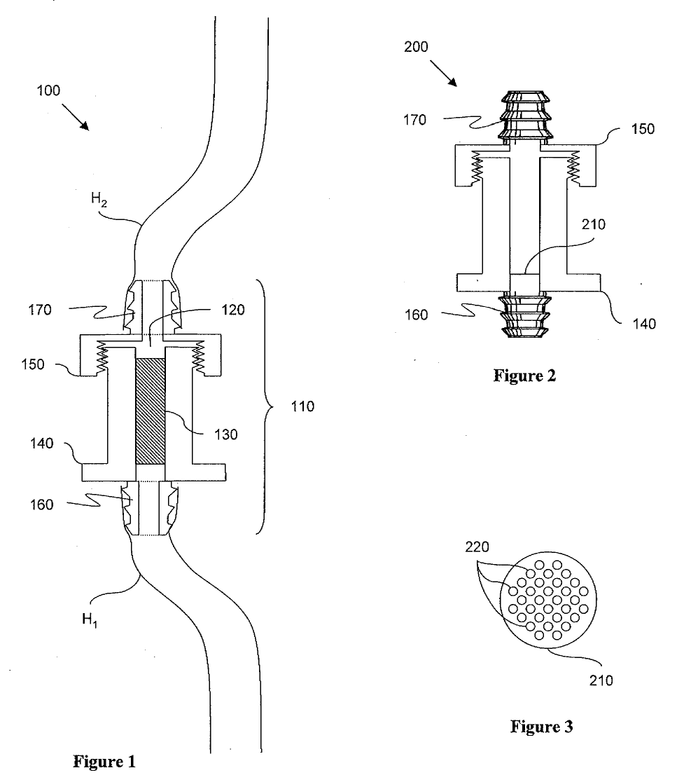

FIG. 1 illustrates a cross-section of one embodiment of an inline filter fitting 100. The inline filter fitting 100 includes a hose splicer 110 having a bore 120 configured to house a filter cartridge 130. The filter cartridge 130 may be any known type of filter cartridge.

In the illustrated embodiment, the hose splicer 110 has a male component 140 and a female component 150. Here, the male component 140 includes the bore 120 that houses the filter cartridge 130. In an alternative embodiment (not shown), the filter cartridge 130 is housed within the female component 150.

With continued reference to FIG. 1, the ends of the male component 140 and the female component 150 are threaded, such that the male component 140 may be screwed into the female component 150. In an alternative embodiment (not shown), the male and female components include quick connect attachments, such as a ball-and-release attachment or a snap-to-connect (STC) attachment. In another alternative embodiment (not shown), the male component is friction fit into the female component and the components may additionally be crimped or rolled to seal the connection. In yet another alternative embodiment (not shown), the male and female components are permanently attached by brazing or welding.

In this embodiment, the filter cartridge 130 is fixedly attached to the male component 140 by a friction fit. In an alternative embodiment (not shown), the filter cartridge 130 is fixedly attached to the male component 140 via brazing or welding. In another alternative embodiment (not shown), the male component 140 is crimped or rolled to fixedly encase the filter cartridge 130.

In the illustrated embodiment, the hose splicer 110 further includes at least a first connector 160 configured to connect to a first hose H₁ and a second connector 170 configured to connect to a second hose H₂. In the illustrated embodiment, the first and second connectors 160, 170 are barbed nipple connectors configured to create a sealed connection with flexible hoses. In an alternative embodiment (not shown), the first and second hoses H₁, H₂ have rigid ends that are crimped or rolled to create a seal with the first and second connectors. In another alternative embodiment (not shown), the connectors include gaskets or O-rings to create a sealed connection with the hoses. It should be understood that sockets (not shown) or hose clamps (not shown) may additionally be used to maintain a connection between the first and second hoses H₁, H₂ and the first and second connectors 160, 170. Such sockets or hose clamps may be crimped or rolled to fix the hoses in place. It should also be understood that the hose splicer 110 may include three or more connectors for use in assemblies having three or more hoses.

The filter 130 may be replaced by opening the hose splicer 110, or separating it into two or more components, so that the filter cartridge 130 may be removed and replaced with another filter cartridge (not shown). Alternatively, the filter 130 may be replaced by removing the hose splicer 110 from the first and second hoses H₁, H₂, and replacing the entire hose splicer 110 with another hose splicer (not shown). In another alternative embodiment, the filter 130 may be replaced by separating the male component 140 from the female component 150 and replacing the male component 140 with another male component (not shown) having a clean filter.

FIG. 2 illustrates a partial cross-section of an alternative embodiment of an inline filter fitting 200 substantially similar to the inline filter fitting 100 disclosed and illustrated in FIG. 1, with the exception of the filter cartridge 130. In the illustrated embodiment, a simple screen filter 210 is employed in place of a filter cartridge. In one embodiment, the filter screen 210 is an integral part of the male component 140. In an alternative embodiment, the filter screen 210 is a separate component. FIG. 3 illustrates a top view of one embodiment of a filter screen 210 having a plurality of apertures 220. It should be understood that the size and number of apertures may vary according to the application to trap certain size particles and debris.

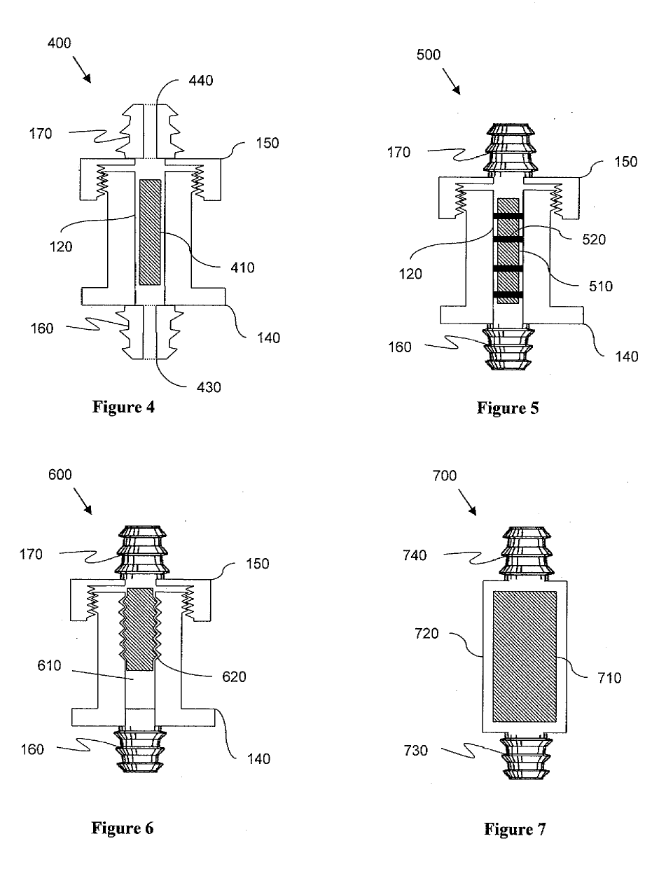

FIG. 4 illustrates a cross-section of another alternative embodiment of an inline filter fitting 400 substantially similar to the inline filter fitting 100 disclosed and illustrated in FIG. 1, with the exception of the filter cartridge 130. In this embodiment, a bore 120 in the male component 140 houses a filter cartridge 410, but not in a fixed position. Instead, the filter cartridge 410 “floats” within the bore 120. In this arrangement, the bore 120 has a larger dimension (i.e., diameter) than a passageway 430 of the first connector 160 and a passageway 440 of the second connector 170. The filter cartridge 410 has a smaller dimension (i.e., diameter) than the bore 120, but has a larger dimension (i.e., diameter) than either passageway 430, 440 of the first and second connectors 160, 170. Therefore, the filter cartridge 410 may move within the inline filter fitting 400, but it is confined within the bore 120 by the connectors 160, 170.

FIG. 5 illustrates a partial cross-section of another alternative embodiment of an inline filter fitting 500 substantially similar to the inline filter fitting 100 disclosed and illustrated in FIG. 1, with the exception of the filter cartridge 130. In this embodiment, the bore 120 of the male component 140 houses a filter cartridge 510 that has a smaller dimension (i.e., diameter) than the bore 120, similar to the filter cartridge 410 of the inline filter fitting 400 of FIG. 4. However, in this embodiment, the filter cartridge 510 does not “float,” but is instead sealed in a fixed position by one or more O-rings 520. In an alternative embodiment (not shown), the filter cartridge 510 is sealed in a fixed position by one or more gaskets.

FIG. 6 illustrates a partial cross-section of another alternative embodiment of an inline filter fitting 600 substantially similar to the inline filter fitting 100 disclosed and illustrated in FIG. 1, with the exception of the bore 120 and the filter cartridge 130. In the illustrated embodiment, a bore 610 in the male component 140 has internal threads. A filter cartridge 620 has corresponding external threads. The filter cartridge 620 is therefore configured to be screwed into the threaded bore 610. The threads maintain the filter cartridge 620 in a fixed and sealed position.

FIG. 7 illustrates a partial cross-section of another alternative embodiment of an inline filter fitting 700. The inline filter fitting 700 is a unitary, disposable inline filter fitting. The inline filter fitting 700 includes a filter cartridge 710 in a unitary housing 720. The unitary housing 720 includes first and second connectors 730, 740 substantially similar to the first and second connectors 160, 170 of the inline filter fitting 100 disclosed and illustrated in FIG. 1. The filter cartridge 710 alone is not replaceable. Instead, when the filter cartridge 710 needs to be replaced, the entire inline filter fitting 700 is removed from fluid line and is discarded. The inline filter fitting 700 is then replaced with a clean inline filter fitting (not shown).

In an alternative embodiment, the filter 710 is fixed within the housing 720. The filter 710 may be fixed in position by any known means. For example, the filter 710 may be fixed in position via a friction fit, or by crimping or rolling the housing 720. Alternatively, the filter 710 and the housing 720 may have threaded ends, and the filter 710 may be screwed into the housing 720. In another known embodiment, the filter 710 may be welded or brazed in its position. In yet another embodiment (not shown), the filter 710 may be sealed in a fixed position by gaskets or O-rings. In alternative embodiments (not shown), any of the filter cartridges or screens described above with reference to FIGS. 1-6, or any other filters may be employed in place of the filter cartridge 710.

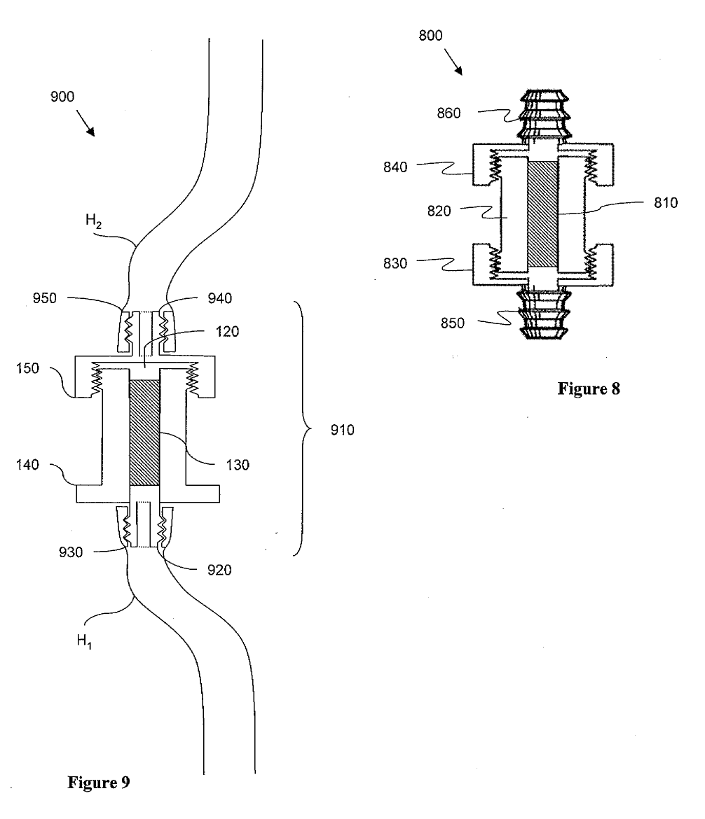

FIG. 8 illustrates a partial cross-section of another alternative embodiment of an inline filter fitting 800. In this embodiment, the inline filter fitting 800 includes a filter cartridge 810 housed in a central male component 820, a first female component 830, and a second female component 840. In alternative embodiments (not shown), any of the filter cartridges or screens described above with reference to FIGS. 1-7, or any other filters may be employed in place of the filter cartridge 810.

With continued reference to FIG. 8, the first female component 830 includes a first connector 850 substantially similar to the first connector 160 of the inline filter fitting 100 disclosed and illustrated in FIG. 1. Further, the second female component 840 includes a second connector 860 substantially similar to the second connector 170 of the inline filter fitting 100 disclosed and illustrated in FIG. 1. The central male component 820 is configured to be attached at a first end to the first female component 830 and is further configured to be attached at a second end to the second female component 840. In the illustrated embodiment, the components are attached via threaded ends. In an alternative embodiment (not shown), the components may be attached through quick connect means, such as a ball-and-release connection or a snap-to-connect connection. In another alternative embodiment (not shown), the components are attached by a friction fit and may be further fixed in place by crimping or rolling the female components. In yet another alternative embodiment (not shown), the components may be welded or brazed together.

FIG. 9 illustrates an alternative embodiment of an inline filter fitting 900. A filter cartridge 130 is housed in a hose splicer 910 removably connected to a first hose H₁ and a second hose H₂. The filter cartridge 130 may be any known type of filter cartridge and may be housed in the hose splicer 910 via any of the means described above in reference to FIGS. 1-7, or by any other known means.

In the illustrated embodiment, the hose splicer 910 has a male component 140 and a female component 150, similar to the hose splicer 110 illustrated in FIG. 1. In alternative embodiments (not shown), the hose splicer may be a unitary device, such as the inline filter fitting 700 illustrated in FIG. 7, or it may have three or more components, such as the inline filter fitting 800 illustrated in FIG. 8. In the illustrated embodiment, the hose splicer 910 includes a filter cartridge 130 substantially the same as the filter cartridge 130 described above in reference to FIG. 1. In alternative embodiments (not shown), any of the filter cartridges or screens described above in reference to FIGS. 2-8, or any other filter may be employed in place of the filter cartridge 130.

In the illustrated embodiment, the hose splicer 910 further includes a first threaded connector 920 having external threads configured to connect to internal threads of a threaded end 930 of the first hose H₁. The hose splicer 910 further includes a second threaded connector 940 having external threads configured to connect to internal threads of a threaded end 950 of the second hose H₂. It should be understood that the hose splicer 910 may include three or more threaded connectors for use in assemblies having three or more hoses. It also should be understood that sockets (not shown) or hose clamps (not shown) may additionally be used to maintain a connection between the hoses H₁, H₂ and the first and second threaded connectors 920, 940. The sockets or hose clamps may be crimped or rolled to fix the hoses in place.

The above described embodiments allow flexibility to locate a filter within any hose assembly in a hydraulic system or any other known fluid line. There are many known methods of attachment that could be used for connecting the two halves of the inline filter fitting, connecting the fitting to hoses, or housing the filter within the fitting. The disclosed embodiments should not be taken to be limiting.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

While the present application illustrates various embodiments, and while these embodiments have been described in some detail, it is not the intention of the applicant to restrict or in any way limit the scope of the claimed invention to such detail. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's claimed invention. Moreover, the foregoing embodiments are illustrative, and no single feature or element is essential to all possible combinations that may be claimed in this or a later application.

What is claimed is:

1. An inline filter fitting comprising:
a filter;
a first member having a bore configured to house the filter; and
a second member removably connected to the first member.

2. The inline filter fitting of claim 1, wherein the first member includes at least a first connector configured to connect to a first hose and the second member includes at least a second connector configured to connect to a second hose.

3. The inline filter fitting of claim 2, wherein the first connector is selected from the group consisting of a nipple, a threaded connector, a ball-and-release connector, and a snap-to-connect connector and the second connector is selected from the group consisting of a nipple, a threaded connector, a ball-and-release connector, and a snap-to-connect connector.

4. The inline filter fitting of claim 1, wherein the filter is a filter cartridge.

5. The inline filter fitting of claim 1, wherein the filter is a screen.

6. The inline filter fitting of claim 1, wherein the filter is fixed in place by a gasket or an O-ring.

7. The inline filter fitting of claim 1, wherein the filter is fixed in place by a process selected from the group consisting of brazing, welding, crimping, and rolling.

8. The inline filter fitting of claim 1, wherein the filter is fixed in place by a connection selected from the group consisting of a friction fit, a threaded connection, a ball-and-release connection, and a snap-to-connect connection.

9. The inline filter fitting of claim 1, wherein the filter is housed in a non-fixed position.

10. The inline filter fitting of claim 1, wherein the first member is a male fitting and the second member is a female fitting configured to be removably connected to the male fitting by one of a gasket, an O-ring, a brazing process, a welding process, a crimping process, a rolling process, a friction fit, a threaded connection, a ball-and-release connection, and a snap-to-connect connection.

11. An inline filter fitting comprising:
a housing having at least two connectors, including a first connector configured to be attached to a first hose and a second connector configured to be attached to a second hose; and
a filter disposed in the housing.

12. The inline filter fitting of claim 11, wherein the housing includes a male fitting and a female fitting removably connected to the male fitting.

13. The inline filter fitting of claim 11, wherein the housing includes a first female fitting, a second female fitting, and a male fitting having a first end configured to be removably connected to the first female fitting and a second end configured to be removably connected to the second female fitting.

14. The inline fitting of claim 13, wherein the male fitting includes a bore configured to house the filter.

15. The inline filter fitting of claim 11, wherein the housing is a unitary component.

16. The inline filter fitting of claim 11, wherein the at least two connectors include at least one of a nipple, a threaded connector, a ball-and-release connector, and a snap-to-connect connector.

17. A filter assembly comprising:
a filter;
a housing having a bore configured to house the filter;
a first connector configured to connect to a first hose; and
a second connector configured to connect to a second hose.

18. The filter assembly of claim 17, wherein the first connector is one of a nipple, a threaded connector, a ball-and-release connector, and a snap-to-connect connector and the second connector is one of a nipple, a threaded connector, a ball-and-release connector, and a snap-to-connector.

19. The filter assembly of claim 17, wherein the housing includes at least one male fitting and at least one female fitting removably connected to the male fitting.

20. The filter assembly of claim 17, wherein the housing is a unitary component.
